(19) United States
(12) Patent Application Publication
(10) Pub. No.: US 2016/0288649 A1
(43) Pub. Date: Oct. 6, 2016

(54) VEHICLE AND CHARGING AND DISCHARGING SYSTEM USING VEHICLE

(71) Applicant: TOYOTA JIDOSHA KABUSHIKI KAISHA, Toyota-shi, Aichi-ken (JP)

(72) Inventors: Tomoya ONO, Toyota-shi (JP); Hironobu KUSAFUKA, Miyoshi-shi (JP)

(73) Assignee: TOYOTA JIDOSHA KABUSHIKI KAISHA, Toyota-shi, Aichi-ken (JP)

(21) Appl. No.: 15/035,339

(22) PCT Filed: Nov. 7, 2014
(86) PCT No.: PCT/IB2014/002365

§ 371 Date: May 9, 2016

(30) Foreign Application Priority Data
Nov. 14, 2013 (JP) 2013-236057

(51) Int. Cl. B60L 3/04; H02J 7/00; B60L 3/00; B60L 11/18; B60L 1/00

(52) U.S. Cl. CPC B60L 3/04; B60L 11/1816; B60L 11/184; B60L 11/1842; B60L 1/006; B60L 3/0046; H02J 7/0026; B60L 2230/12; B60L 2270/20; B60L 2240/549

(57) ABSTRACT

A vehicle includes an electric storage device, an inlet, and a bidirectional thyristor. The bidirectional thyristor includes a first electrode and a second electrode. The first electrode is connected to the inlet and the second electrode is connected to the electric storage device. The bidirectional thyristor is configured to cause a DC current to flow in a direction from the first electrode to the second electrode in a charging mode and to cause a DC current to flow in a direction from the second electrode to the first electrode in a discharging mode. The charging mode is a mode in which DC power supplied from the charging and discharging device is stored in the electric storage device and the discharging mode is a mode in which DC power of the electric storage device is supplied to the charging and discharging device.

### BACKGROUND OF THE INVENTION

1. Field of the Invention

The present invention relates to a vehicle and a charging and discharging system using the vehicle, and more particularly, to a vehicle equipped with an electric storage device and a charging and discharging system using the vehicle.

2. Description of Related Art

In recent years, a charging device has been developed which converts commercial AC power into DC power and which supplies the DC power to an electric storage device of a vehicle such as an electric vehicle. Japanese Patent Application Publication No. 2012-70577 (JP 2012-70577 A) discloses a discharging device that converts DC power of an electric storage device of a vehicle into AC power and that supplies the AC power to a load.

However, when the charging device and the discharging device are individually provided, efficiency is poor and thus there is demand for development of a charging and discharging device capable of performing both charging and discharging of an electric storage device of a vehicle. When such a charging and discharging device is used, it is assumed that the same cable as in the related art is used. This cable includes a connector connected to an inlet of a vehicle, a fuse, and a power line. In the vehicle, a relay and a fuse are disposed between the inlet and the electric storage device (see FIG. 2A).

When the charging and discharging device and the inlet of the vehicle are connected to each other via the cable and the electric storage device is discharged, it is thought that a power line short-circuits and an overcurrent flows from the electric storage device into the short-circuited portion of the power line. When the fuse of the vehicle is not melted down but the relay is fixed to the ON state, and the fuse of the cable is melted down, a state may be maintained in which the voltage of the electric storage device is applied to the inlet of the vehicle (see FIG. 2B).

### SUMMARY OF THE INVENTION

Therefore, the invention provides a vehicle capable of preventing a voltage of an electric storage device from being exposed at the time of breakdown and a charging and discharging system using the vehicle.

A vehicle according to the invention has the following configuration. The vehicle comprising an electric storage device, an inlet, and a bidirectional thyristor. The electric storage device is configured to store DC power. The inlet is connected to an external charging and discharging device via a cable. The bidirectional thyristor includes a first electrode and a second electrode. The first electrode is connected to the inlet. The second electrode is connected to the electric storage device. The bidirectional thyristor is configured to cause a DC current to flow in a direction from the first electrode to the second electrode in a charging mode. The bidirectional thyristor is configured to cause a DC current to flow in a direction from the second electrode to the first electrode in a discharging mode. The charging mode is a mode in which DC power supplied from the charging and discharging device is stored in the electric storage device. The discharging mode is a mode in which DC power of the electric storage device is supplied to the charging and discharging device.

Therefore, according to the invention, when the charging and discharging device and the inlet of the vehicle are connected to each other via the cable and the electric storage device is discharged and when an overcurrent flows and the fuse on the charging and discharging device side is melted, the bidirectional thyristor is turned off and the inlet of the vehicle and the electric storage device are electrically disconnected from each other. Accordingly, it is possible to prevent the voltage of the electric storage device from being exposed at the time of breakdown.

The vehicle may further include a relay of which one terminal is connected to the second electrode of the bidirectional thyristor and which is turned on in the charging mode and the discharging mode and a first fuse connected between the other terminal of the relay and the electric storage device.

In this case, since the relay is provided, the inlet and the electric storage device can be electrically disconnected from each other in an operation mode other than the charging mode and the discharging mode. Since the first fuse is provided, it is possible to prevent an overcurrent from flowing between the inlet and the electric storage device.

The cable may include a connector connected to the inlet, a second fuse of which one terminal is connected to the connector, and a power line connected between the other terminal of the second fuse and the charging and discharging device.

In this case, since the second fuse is provided, it is possible to prevent an overcurrent from flowing in the cable. When the power line short-circuits in the discharging mode, the first fuse is not melted, the relay is secured in the ON state, and the second fuse is melted, a current is intercepted and the bidirectional thyristor is turned off. Accordingly, it is possible to prevent the voltage of the electric storage device from being applied to the inlet and to safely remove the connector.

A charging and discharging system according to the invention includes the vehicle, the cable, and the charging and discharging device. The charging and discharging device is configured to convert AC power supplied form a commercial AC power source into DC power and to supply the DC power to the electric storage device via the cable in the charging mode. The charging and discharging device is configured to convert DC power supplied via the cable from the electric storage device into AC power and supply the AC power to a load in the discharging mode. In this case, it is possible to reduce peaks in power consumption, to reduce electric rates in homes, and to utilize an electrical device even in an emergency such as power failure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a circuit block diagram illustrating principal parts of a charging system serving as the basis of the invention;

FIG. 1B is a circuit block diagram illustrating principal parts of a charging system serving as the basis of the invention;

FIG. 2A is a circuit block diagram illustrating principal parts of a charging and discharging system using the charging system illustrated in FIG. 1A and FIG. 1B;

FIG. 2B is a circuit block diagram illustrating principal parts of a charging and discharging system using the charging system illustrated in FIG. 1A and FIG. 1B;

FIG. 3 is a circuit block diagram illustrating principal parts of a charging and discharging system according to an embodiment of the invention;

FIG. 4 is a circuit block diagram illustrating a configuration of a vehicle illustrated in FIG. 3; and

FIG. 5 is a circuit block diagram illustrating a configuration of an AC charging cable connected to the vehicle illustrated in FIG. 4.

### DETAILED DESCRIPTION OF EMBODIMENTS

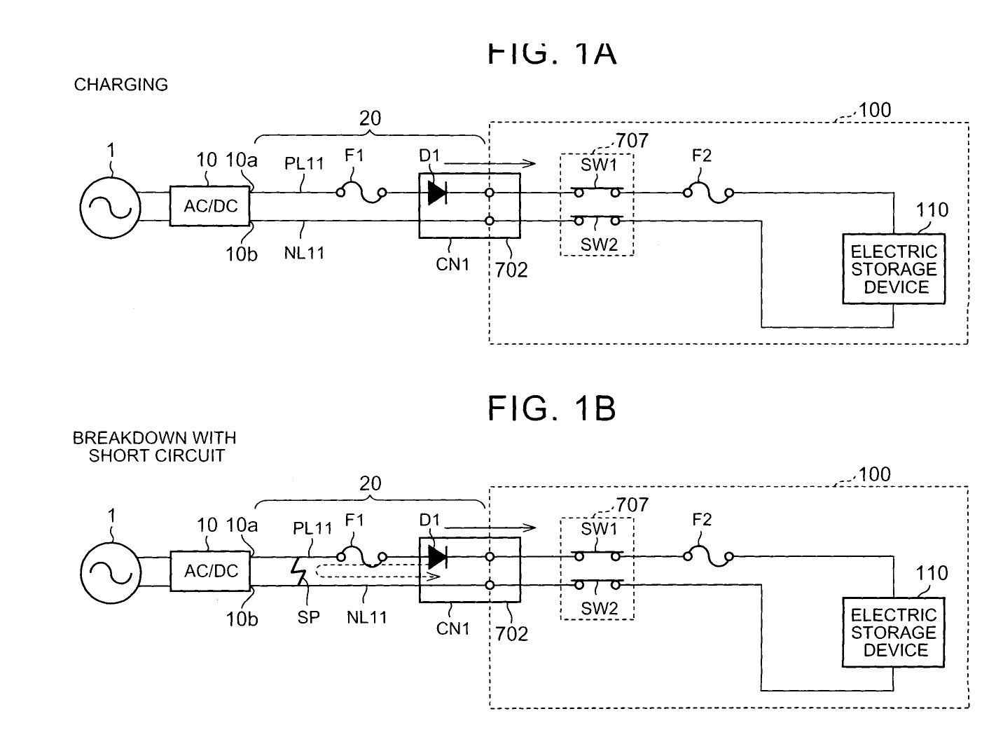

FIG. 1A is a circuit block diagram illustrating principal parts of a charging system serving as the basis of the invention. In FIG. 1A, the charging system includes a charging device 10, a cable 20, and a vehicle 100. The cable 20 includes a positive power line PL11, a negative power line NL11, a fuse F1, a diode D1, and a connector CN1.

One end of the positive power line PL11 is connected to a positive voltage terminal 10a of the charging device 10. One terminal of the fuse F1 is connected to the other end of the positive power line PL11. The fuse F1 is melted down to protect the cable 20 or the like when a current larger than a predetermined rated current flows. The diode D1 is received in the connector CN1, the anode thereof is connected to the other terminal of the fuse F1, and the cathode thereof is connected to a positive voltage terminal of the connector CN1. The diode D1 prevents a DC current from flowing backward from the vehicle 100 to the charging device 10. The negative power line NL11 is connected between a negative voltage terminal 10b of the charging device 10 and a negative voltage terminal of the connector CN1.

The vehicle 100 includes a DC inlet 702, a DC relay 707, a fuse F2, and an electric storage device 110. The DC relay 707 includes switches SW1, SW2. The switches SW1, SW2 are switched to a connected state in a charging mode in which the electric storage device 110 is charged. A positive voltage terminal of the DC inlet 702 is connected to a positive electrode of the electric storage device 110 via the switch SW1 and the fuse F2. The fuse F2 is melted down to protect the electric storage device 110 or the like when a current larger than a predetermined rated current flows. The rated current of the fuse F2 is equal to the rated current of the fuse F1. A negative voltage terminal of the DC inlet 702 is connected to a negative electrode of the electric storage device 110 via the switch SW2.

When the connector CN1 is inserted into the DC inlet 702, the positive voltage terminal and the negative voltage terminal of the connector CN1 and the positive voltage terminal and the negative voltage terminal of the DC inlet 702 are connected to each other, respectively. When an instruction to start charging is given, the switches SW1, SW2 of the DC relay 707 are switched to the connected state. The charging device 10 includes an AC/DC converter, converts AC power from a commercial AC power source 1 into DC power, and supplies the DC power to the electric storage device 110 of the vehicle 100 via the cable 20. Accordingly, the DC power is stored in the electric storage device 110.

When charging of the electric storage device 110 ends, the switches SW1, SW2 of the DC relay 707 are switched to a disconnected state. The connector CN1 is pulled out of the DC inlet 702 by a user. The vehicle 100 is driven with the DC power of the electric storage device 110 or the like.

As illustrated in FIG. 1B, when the cable 20 is destroyed or cut during charging and the power lines PL11, NL11 short-circuit, output terminals 10a, 10b of the charging device 10 are in a floating state by a protection circuit of the charging device 10. Since the diode D1 becomes a reverse bias and is in a disconnected state, a current does not flow backward from the electric storage device 110 to the short-circuited portion SP. When the DC relay 707 is switched to the disconnected state by the user, the DC inlet 702 and the electric storage device 110 are electrically disconnected from each other and the connector CN1 can be safely detached.

JP 2012-70577 A discloses the discharging device that converts DC power of the electric storage device of the vehicle into AC power and that supplies the AC power to a load. When the charging device and the discharging device are individually provided, the efficiency is poor and thus there is demand for development of a charging and discharging device capable of performing both charging and discharging of the electric storage device 110 of the vehicle 100.

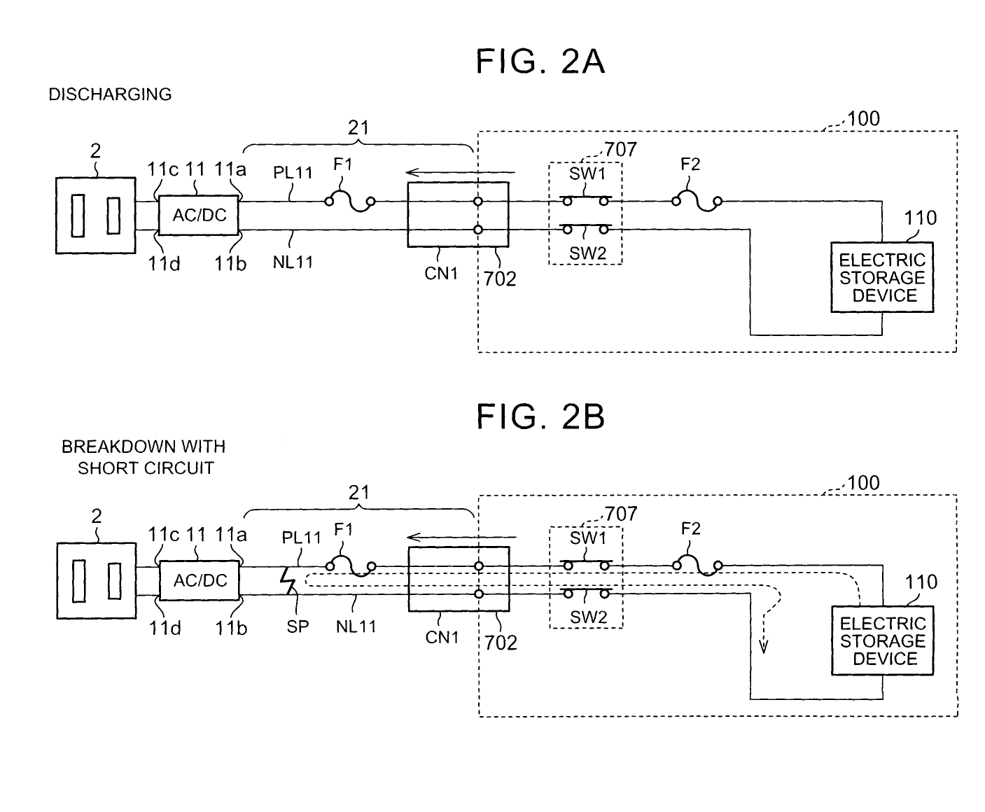

FIG. 2A is a circuit block diagram illustrating principal parts of a charging and discharging system using the charging system illustrated in FIGS. 1A and is a diagram which is contrasted with FIG. 1A. Referring to FIG. 2A, the charging and discharging system is different from the charging system illustrated in FIG. 1A, in that the charging device 10 is replaced with a charging and discharging device 11 and the cable 20 is replaced with a cable 21. The cable 21 is obtained by removing the backflow-preventing diode D1 from the cable 20. The ends on one side of the power lines PL11, NL11 are connected to a positive voltage terminal 11a and a negative voltage terminal 11b of the charging and discharging device 11, respectively.

The charging and discharging device 11 includes a bidirectional AC/DC converter, and AC terminals 11c, 11d are connected to a household plug socket 2. The plug socket 2 is supplied with AC power from the commercial AC power source 1 and is connected to a household electrical device (load) via a plug (not illustrated). When an instruction to start charging or discharging is given, the switches SW1, SW2 of the DC relay 707 in the vehicle 100 are turned on.

In the charging mode, similarly to the charging device 10, the charging and discharging device 11 converts AC power supplied from the commercial AC power source 1 connected to the plug socket 2 into DC power and supplies the DC power to the electric storage device 110 of the vehicle 100 via the cable 21. In the discharging mode, the charging and discharging device 11 converts DC power supplied from the electric storage device 110 via the cable 21 into AC power and supplies the AC power to the commercial AC power source 1 and the household electrical device (load) connected to the plug socket 2. The AC power supplied to the commercial AC power source 1 is used, for example, by another household electrical device (load).

According to this charging and discharging system, it is possible to reduce peaks in power consumption by charging the electric storage device 110 in a time zone in which the power consumption is small and discharging the electric storage device 110 in a time zone in which the power consumption is great. In the time zone in which the power consumption is small, power rates are low and thus the power rates of home can be saved. The household electrical device can be utilized even in emergency such as power failure.

However, as illustrated in FIG. 2B, when the cable 21 is destroyed or cut in the discharging mode and the power lines PL11, NL11 short-circuit, a large current flows from the positive electrode of the electric storage device 110 into the negative electrode of the electric storage device 110 via the fuse F2, the switch SW1, the fuse F1, the short-circuited portion SP, and the switch SW2.

When a large current flows into the DC relay 707, electrical repulsion (electromagnetic repulsion) occurs and the switches SW1, SW2 are about to be turned off. Since are discharge occurs at this time, the switches SW1, SW2 are melted and secured and are fixed to the connected state. That is, the DC relay 707 is secured to the ON state and is fixed to the connected state. When the fuse F1 is melted down earlier than the fuse F2, the short-circuit current is intercepted, but the inter-terminal voltage of the electric storage device 110 is applied across the terminals of the DC inlet 702.

When the user pulls out the connector CN1 from the DC inlet 702 in this state, the terminal of the DC inlet 702 to which the voltage of the electric storage device 110 is applied is exposed. The invention is made to avoid such a case.

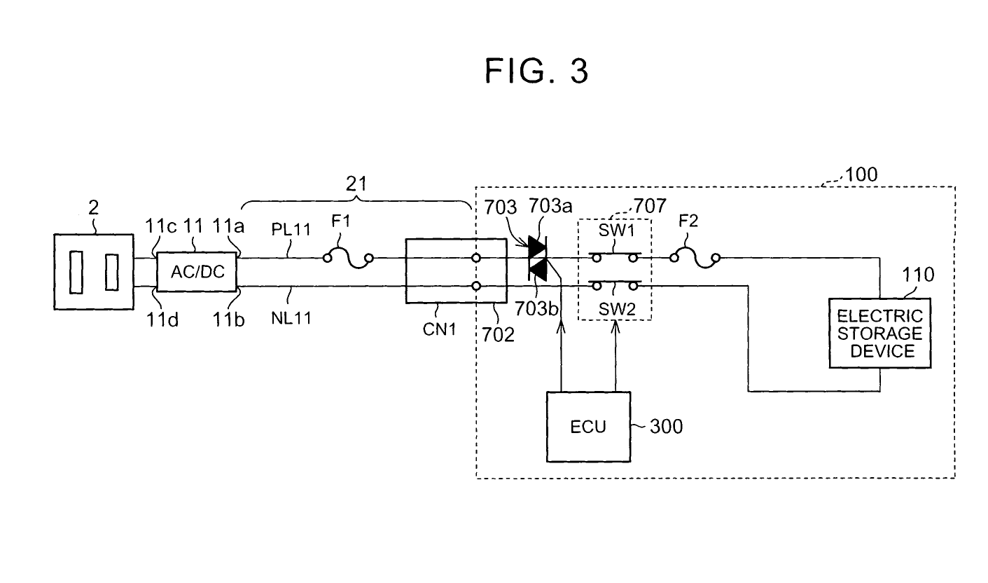

FIG. 3 is a circuit block diagram illustrating principal parts of a charging and discharging system according to an embodiment of the invention and is a diagram contrasted with FIG. 2A. Referring to FIG. 3, this charging and discharging system is different from the charging and discharging system illustrated in FIG. 2A, in that the vehicle 100 is replaced with a vehicle 101. The vehicle 101 has a configuration in which a bidirectional thyristor 703 and an electronic control Unit (ECU) 300 are added to the vehicle 100.

The bidirectional thyristor 703 includes two thyristors of a thyristor 703a and a thyristor 703b connected in antiparallel. The anode of the thyristor 703a and the cathode of the thyristor 703b are connected to each other to form a first electrode of the bidirectional thyristor 703. The cathode of the thyristor 703a and the anode of the thyristor 703b are connected to each other to form a second electrode of the bidirectional thyristor 703. The gate of the thyristor 703a and the gate of the thyristor 703b are connected to each other to form the gate of the bidirectional thyristor 703.

The first electrode of the bidirectional thyristor 703 is connected to the positive voltage electrode of the DC inlet 702, the second electrode thereof is connected to the positive electrode of the electric storage device 110 via the switch SW1 and the fuse F2, and the gate thereof is connected to the ECU 300.

Initially, the bidirectional thyristor 703 is in a disconnected state. When a charging start instruction is given, the charging and discharging device 11 converts AC power supplied from a commercial AC power source 1 connected to the plug socket 2 into DC power and supplies the DC power to the vehicle 101 via the cable 21. The ECU 300 turns on the switches SW1, SW2 of the DC relay 707.

Accordingly, the voltage of the first electrode of the bidirectional thyristor 703 becomes higher than the voltage of the second electrode and a forward bias voltage is applied to the thyristor 703a. In this state, the ECU 300 supplies a pulse signal to the gate of the bidirectional thyristor 703. Accordingly, the thyristor 703a is turned on, a DC current flows in a direction from the first electrode to the second electrode, and the electric storage device 110 is charged.

When the charging of the electric storage device 110 ends, the operation of the charging and discharging device 11 stops and the switches SW1, SW2 of the DC relay 707 are turned off. Accordingly, a current does not flow in the thyristor 703a, the bidirectional thyristor 703 is turned off, and the DC inlet 702 and the electric storage device 110 are electrically disconnected from each other. The connector CN1 is removed from the DC inlet 702 by a user. The vehicle 101 is driven with DC power of the electric storage device 110 or the like.

When the power lines PL11, NL11 short-circuit during charging, the terminals 11a, 11b of the charging and discharging device 11 are switched to a floating state and the operation of the charging and discharging device 11 is stopped by a protection circuit of the charging and discharging device 11. Accordingly, the inter-terminal voltage of the electric storage device 110 is applied across the cathode and the anode of the thyristor 703a and the thyristor 703a is changed to an inverse bias state and is turned off.

Accordingly, a current does not flow backward from the electric storage device 110 to the short-circuited portion of the power lines PL11, NL11. The DC inlet 702 and the electric storage device 110 are electrically disconnected from each other, and thus the voltage of the electric storage device 110 is not exposed to the DC inlet 702 when the user pulls out the connector CN1.

When a discharging start instruction is given, the switches SW1, SW2 of the DC relay 707 are turned on by the ECU 300, the voltage of the electric storage device 110 is applied to the bidirectional thyristor 703, and a forward bias voltage is supplied to the thyristor 703b. In this state, the ECU 300 supplies a pulse signal to the gate of the bidirectional thyristor 703. Accordingly, the thyristor 703b is turned on and a DC current flows in a direction from the second electrode to the first electrode.

The charging and discharging device 11 converts DC power supplied via the cable 21 from the electric storage device 110 into AC power of a commercial frequency and supplies the AC power to the commercial AC power source 1 connected to the plug socket 2 or a household electrical device. Accordingly, it is possible to reduce peaks in power consumption and to reduce electrical rates in homes.

When the power lines PL11, NL11 short-circuit during discharging, an overcurrent flows from the electric storage device 110 to the short-circuited portion SP, at least one fuse F of the fuses F1, F2 is melted, the current flowing in the thyristor 703b is intercepted, and the thyristor 703b is turned off. The operation of the charging and discharging device 11 is stopped by the protection circuit of the charging and discharging device 11.

Even when electromagnetic repulsion occurs in the DC relay 707 by the short-circuit current, the switches SW1, SW2 are secured in the ON state, the fuse F1 is first melted, and the fuse F2 is not melted, the bidirectional thyristor 703 is turned off and the DC inlet 702 and the electric storage device 110 are electrically disconnected from each other. Accordingly, the user can safely remove the connector CN1 from the DC inlet 702.

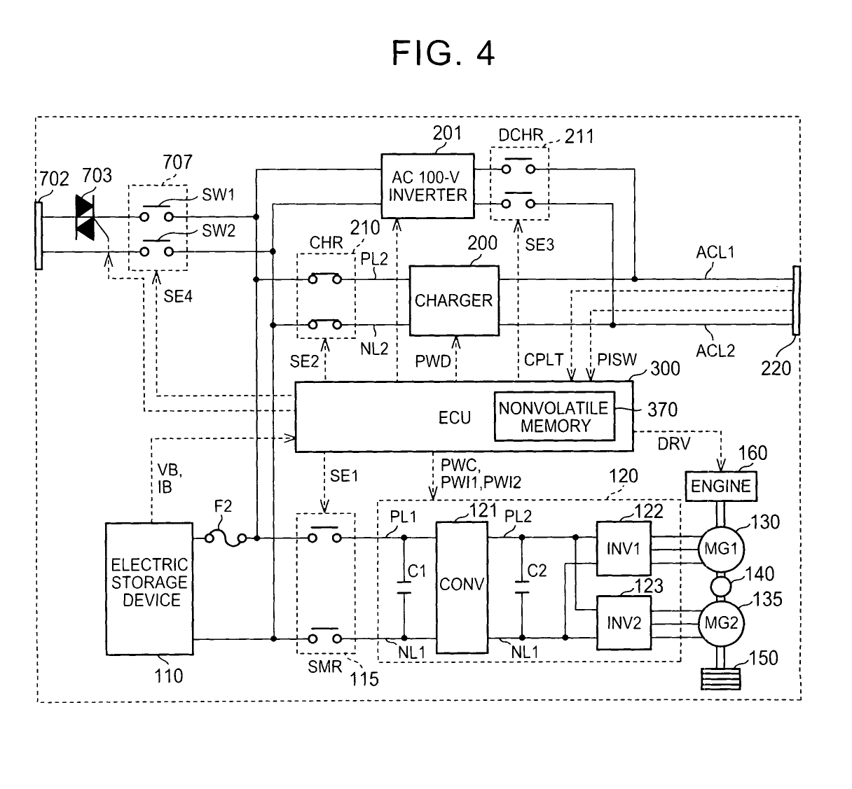

FIG. 4 is a circuit block diagram illustrating the configuration of the vehicle 101 illustrated in FIG. 3 in detail. In FIG. 4, the vehicle 101 is a hybrid vehicle and includes an electric storage device 110, a fuse F2, a system main relay (SMR) 115, a power control unit (PCU) 120, motor-generator sets 130, 135, a power transmission gear 140, driving wheels 150, an engine 160, and an ECU 300 as a controller. The PCU 120 includes a converter 121, inverters 122, 123, and capacitors C1, C2.

The electric storage device 110 is a power storage element configured to be chargeable and dischargeable. The electric storage device 110 includes a secondary battery such as a lithium-ion battery, a nickel-hydrogen battery, and a lead storage battery or an electric storage element such as an electrical double-layer capacitor.

The electric storage device 110 is connected to the PCU 120 via the fuse F2, the SMR 115, the positive power line PL1, and the negative power line NL1. The electric storage device 110 supplies the PCU 120 with power for generating a drive force of the vehicle 101. The electric storage device 110 stores power generated by the motor-generator sets 130, 135. The output of the electric storage device 110 is, for example, about 200 V.

The electric storage device 110 includes a voltage sensor and a current sensor which are not illustrated and outputs the voltage VB and the current IB of the electric storage device 110 detected by the sensors to the ECU 300.

One terminal of the switch on the positive voltage side out of two switches of the SMR 115 is connected to the positive electrode of the electric storage device 110 via the fuse F2, and the other terminal thereof is connected to the converter 121 via the positive power line PL1. One terminal of the switch on the negative voltage side out of two switches of the SMR 115 is connected to the negative electrode of the electric storage device 110, and the other terminal thereof is connected to the converter 121 via the negative power line NL1.

The SMR 115 switches the supply of power and the stop of power supply between the electric storage device 110 and the PCU 120 on the basis of a control signal SE1 from the ECU 300. The fuse F2 is melted down to protect the electric storage device 110 from an overcurrent when the overcurrent flows.

The converter 121 performs voltage conversion between the positive power line PL1 and the negative power line NL1 and between the positive power line PL2 and the negative power line NL1 on the basis of a control signal PWC from the ECU 300.

The inverters 122, 123 are connected in parallel to the positive power line PL2 and the negative power line NL1. The inverters 122, 123 convert DC power supplied from the converter 121 into AC power and drive the motor-generator sets 130, 135, respectively, on the basis of control signals PWI1, PWI2 from the ECU 300.

The capacitor C1 is disposed between the positive power line PL1 and the negative power line NL1 and reduces voltage fluctuation between the positive power line PL1 and the negative power line NL1. The capacitor C2 is disposed between the positive power line PL2 and the negative power line NL1 and reduces voltage fluctuation between the positive power line PL2 and the negative power line NL1.

The motor-generator sets 130, 135 are AC rotary motors, for example, permanent magnet-type synchronous motors including a rotor having a permanent magnet buried therein.

The output torques of the motor-generator sets 130, 135 are transmitted to the driving wheels 150 via the power transmission gear 140 including a reduction gear or a power distribution mechanism so as to cause the vehicle 101 to run. The motor-generator sets 130, 135 can generate electric power by the rotation force of the driving wheels 150 at the time of a generative braking operation of the vehicle 101. The generated electric power is converted into charging power of the electric storage device 110 by the PCU 120.

The motor-generator sets 130, 135 are coupled to the engine 160 via the power transmission gear 140. The motor-generator sets 130, 135 and the engine 160 are operated in cooperation to generate a necessary vehicle driving force by the ECU 300. The motor-generator sets 130, 135 can generate electric power by the rotation of the engine 160 and can charge the electric storage device 110 with the generated electric power. In Embodiment 1, the motor-generator set 135 is used as only an electric motor for driving the driving wheels 150, and the motor-generator set 130 is used as only a power generator driven by the engine 160.

FIG. 4 illustrates the configuration in which two motor-generator sets are provided, but the number of motor-generator sets is not limited to this configuration. A configuration in which the number of motor-generator sets is one or a configuration in which the number of motor-generator sets is two or greater may be employed. The vehicle 101 may be an electric automobile not equipped with an engine or a fuel-cell vehicle.

The vehicle 101 includes the DC inlet 702, the bidirectional thyristor 703, the DC relay 707, and the fuse F2 as the configuration for charging and discharging the electric storage device 110 through the use of the charging and discharging device 11. The configurations and operations thereof have been described above with reference to FIGS. 1 to 3 and thus description thereof will not be repeated.

The vehicle 101 includes a charger 200, a charging relay CHR 210, and an AC inlet 220 as an AC connection unit, as a configuration for charging the electric storage device 110 with power from an external AC power source 500.

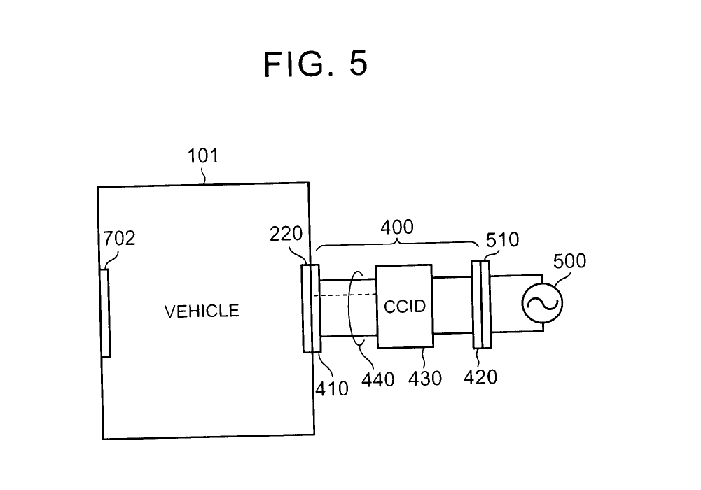

At the time of AC charging and discharging, a charging connector 410 of a charging cable 400 is connected to the AC inlet 220 as illustrated in FIG. 5. Power from the external AC power source 500 is supplied to the vehicle 101 via the charging cable 400.

The charging cable 400 includes a plug 420 for connection to a socket 510 of the external AC power source 500 and a power line 440 for connecting the charging connector 410 and the plug 420 to each other, in addition to the charging connector 410. A charging circuit interrupt device (hereinafter, also referred to as CCID) 430 for switching the supply of power and the stop of power supply from the external AC power source 500 is inserted into the power line 440.

The charger 200 is connected to the AC inlet 220 via power lines ACL1, ACL2. The charger 200 is connected to the electric storage device 110 via the CHR 210 and the fuse F2.

The charger 200 is controlled by a control signal PWD from the ECU 300 and converts AC power supplied from the AC inlet 220 into charging power of the electric storage device 110.

The vehicle 101 further includes an AC 100-V inverter 201 and a discharging relay DCHR 211 as a configuration for supplying electric power to the outside. The AC inlet 220 is also used as a connection portion for outputting AC power.

The AC 100-V inverter 201 is connected to the electric storage device 110 via the fuse F2 and is connected to the PCU 120 via the SMR 115. The AC 100-V inverter 201 can convert DC power from the electric storage device 110 or DC power generated by the motor-generator sets 130, 135 and converted by the PCU 120 into AC power and can supply the AC power to the outside of the vehicle. Another device for outputting AC voltage or DC voltage may be provided instead of the AC 100-V inverter 201. The charger 200 and the AC 100-V inverter 201 may be a single device capable of converting power in both charging and discharging.

The CHR 210 is connected to the electric storage device 110 via the fuse F2 and is connected to the charger 200. The CHR 210 is controlled by a control signal SE2 from the ECU 300 and switches the supply of power and the stop of power supply between the charger 200 and the electric storage device 110. The DCHR 211 is controlled by a control signal SE3 from the ECU 300 and switches the setup and the interruption of a power path between the AC inlet 220 and the AC 100-V inverter 201. At the time of charging illustrated in FIG. 4, the CHR 210 is controlled to enter a connected state and the DCHR 211 is controlled to enter a disconnected state.

The ECU 300 includes a nonvolatile memory 370 for storing initial settings of an air-conditioner or the like. The ECU 300 further includes a central processing unit (CPU), a storage unit, and an input and output buffer which are not illustrated in FIG. 4, performs inputting of a signal from various sensors and the like or outputting of control signals to various units, and controls the electric storage device 110 and the units of the vehicle 101. These controls are not limited to processing by software, but may be processed by dedicated hardware (electronic circuit).

The ECU 300 computes the state of charge (SOC) of the electric storage device 110 on the basis of the detected values of the voltage VB and the current IB from the electric storage device 110.

The ECU 300 receives a proximity detection signal PISW (hereinafter, referred to as detection signal PISW) indicating the connection state of the charging cable 400 from the charging connector 410. The ECU 300 receives a control pilot signal CPLT (hereinafter, referred to as a pilot signal CPLT) from the CCID 430 of the charging cable 400. The ECU 300 performs the charging operation on the basis of the received signals.

FIG. 4 illustrates the configuration in which a single controller is disposed as the ECU 300, but a configuration in which an individual controller is provided for each function or for each control target device, such as a controller for the PCU 120 or a controller for the electric storage device 110, may be employed.

charging and discharging with AC power will be described below. The configurations of the pilot signal CPLT and the detection signal PISW used for charging with AC power, the shapes of the AC inlet 220 and the charging connector 410, the terminal arrangement, and the like are standardized, for example, by the Society of Automotive Engineers (SAE), the International Electrotechnical Commission (IEC), or the like.

The CCID 430 includes a CPU, a storage unit, and an input and output buffer which are not illustrated, inputs and outputs sensor signals and control pilot signals, and controls the charging operation of the charging cable 400.

The potential of the pilot signal CPLT is adjusted by the ECU 300. The duty cycle thereof is set on the basis of the rated current which can be supplied from the external AC power source 500 to the vehicle 101 via the charging cable 400.

The pilot signal CPLT is oscillated in a prescribed period when the potential of the pilot signal CPLT is lowered from a prescribed potential. Here, the pulse width of the pilot signal CPLT is set on the basis of the rated current which can be supplied from the external AC power source 500 to the vehicle 101 via the charging cable 400. That is, the rated current is notified from a control pilot circuit of the CCID 430 to the ECU 300 of the vehicle 101 using the pilot signal CPLT by the duty which is expressed by a ratio of the pulse width to the oscillation period.

The rated current is determined for each charging cable, and the rated current varies depending on the type of the charging cable 400. Therefore, the duty of the pilot signal CPLT varies depending on the charging cable 400.

The ECU 300 can detect the rated current which can be supplied to the vehicle 101 via the charging cable 400 on the basis of the duty of the received pilot signal CPLT.

When a contact of a relay in the CCID 430 is closed, AC power from the external AC power source 500 is supplied to the charger 200 and the charging of the electric storage device 110 with the external AC power source 500 is ready. The ECU 300 converts the AC power from the external AC power source 500 into DC power with which the electric storage device 110 can be charged by outputting the control signal PWD to the charger 200. The ECU 300 performs charging of the electric storage device 110 by outputting the control signal SE2 to close the contact of the CHR 210.

Like a so-called smart grid, it is reviewed that a vehicle is considered as a power source and electric power stored in the vehicle is supplied to an electrical device outside the vehicle. A vehicle may be used as a power source for use of electrical devices in a camp or outdoor work.

In this case, when electric power can be supplied from the vehicle via the AC inlet 220 connected to the charging fable 400 at the time of external charging, it is not necessary to individually provide an outlet for connection to an electrical device and thus there is no necessity for remodeling a vehicle or it is possible to reduce the necessity for remodeling a vehicle, which is suitable.

Accordingly, in Embodiment, AC power can be supplied to an electrical device outside of the vehicle via the AC inlet 220. In this case, a power supply connector (not illustrated) for coupling the AC inlet 220 to a plug of an electrical device is inserted into the AC inlet 220. By insertion of the power supply connector, AC power generated by the AC 100-V inverter 201 can be supplied to a household electrical device.

It should be understood that the above-mentioned embodiments are only examples but not restrictive. The scope of the invention is defined by the appended claims, not by the above-mentioned description, and includes all modifications within the meaning and scope equivalent to the claims.

1-4. (canceled)

5. A vehicle comprising:
an electric storage device configured to store DC power;
an inlet connected to an external charging and discharging device via a cable; and
a bidirectional thyristor including a first electrode connected to the inlet and a second electrode connected to the electric storage device, the bidirectional thyristor being configured to cause a DC current to flow in a direction from the first electrode to the second electrode in a charging mode, the bidirectional thyristor being configured to cause a DC current to flow in a direction from the second electrode to the first electrode in a discharging mode, the charging mode being a mode in which DC power supplied from the external charging and discharging device is stored in the electric storage device, the discharging mode being a mode in which DC power of the electric storage device is supplied to the external charging and discharging device, a relay having one terminal and the other terminal, the one terminal of the relay being connected to the second electrode of the bidirectional thyristor, the relay being turned on in the charging mode and the discharging mode, and
a first fuse connected between the other terminal of the relay and the electric storage device.

6. The vehicle according to claim 5, wherein the cable includes:
a connector connected to the inlet;
a second fuse having one terminal and the other terminal, the one terminal of the second fuse being connected to the connector; and
a power line connected between the other terminal of the second fuse and the external charging and discharging device.

7. A charging and discharging system comprising:
a cable;
an external charging and discharging device; and
a vehicle including;
an electric storage device configured to store DC power;
an inlet connected to the external charging and discharging device via a cable; and
a bidirectional thyristor including a first electrode connected to the inlet and a second electrode connected to the electric storage device, the bidirectional thyristor being configured to cause a DC current to flow in a direction from the first electrode to the second electrode in a charging mode, the bidirectional thyristor being configured to cause a DC current to flow in a direction from the second electrode to the first electrode in a discharging mode, the charging mode being a mode in which DC power supplied from the external charging and discharging device is stored in the electric storage device, the discharging mode being a mode in which DC power of the electric storage device is supplied to the external charging and discharging device, a relay having one terminal and the other terminal, the one terminal of the relay being connected to the second electrode of the bidirectional thyristor, the relay being turned on in the charging mode and the discharging mode, and
a first fuse connected between the other terminal of the relay and the electric storage device,
wherein the external charging and discharging device is configured to convert AC power supplied form a commercial AC power source into DC power and supply the DC power to the electric storage device via the cable in the charging mode, and
the external charging and discharging device is configured to convert DC power supplied via the cable from the electric storage device into AC power and supply the AC power to a load in the discharging mode.
